(19) United States
(12) Patent Application Publication
(10) Pub. No.: US 2025/0252939 A1
(43) Pub. Date: Aug. 7, 2025

(54) Tuning Slide Clip for a Tremolo

(71) Applicant: Modern Electronic Solutions inc, Harrison, MI (US)

(72) Inventor: Kurt H. Snider, Ruskin, FL (US)

(21) Appl. No.: 18/810,033

(22) Filed: Aug. 20, 2024

Related U.S. Application Data
(60) Provisional application No. 63/549,367, filed on Feb. 2, 2024.

(51) Int. Cl. G10D 3/153

(52) U.S. Cl. CPC G10D 3/153

(57) ABSTRACT

A C-shaped tuning slide clip which slidably engages with a guitar tremolo. The tuning slide clip possesses at least one channel, whereby, upon sliding laterally across the tremolo, a string lock screw drops into the channel, thereby manipulating the sound of the instrument. The tuning slide clip is capable of being hooked onto existing tremolos, without requiring the user to disassemble the tremolo. Additionally, in some embodiments, the tuning slide clip includes a toggle screw to prevent disengagement from the tremolo.

### FIELD OF THE INVENTION

The present invention relates generally to an accessory for a guitar tremolo. More specifically, the present invention is a tuning slide clip for a guitar for modifying pitch on a guitar.

### BACKGROUND OF THE INVENTION

The guitar tremolo is a component that functions in modulating pitch while a user is playing the instrument. The tremolo comprises a bridge, springs, and a spring plate, thereby allowing the tremolo system to enable players to alter the tension of the strings, thus adjusting the pitch of the notes produced. This mechanism is widely used, however, the construction of tremolos have created a challenge for users seeking to utilize supplemental tuning mechanism but requiring disassembly of the guitar and tremolo.

The traditional tremolo system consists of a bridge mounted on the guitar body, springs attached to the bridge, and a spring plate secured to the body. When the player engages the tremolo arm, it applies tension to the springs, causing the bridge to pivot and subsequently changing the pitch of the strings. While this construction facilitates an ease of playing, maintaining precise tuning has shown to be a persistent challenge.

Prior art tuning solutions often required disassembly of the guitar, demanding a level of expertise and time that could discourage musicians seeking quick adjustments. These methods typically involved detaching the spring plate, making fine-tuning an arduous and impractical process, especially in live performance settings. Additionally, the existing tuning devices were often cumbersome, negatively impacting the guitar's aesthetics and hindering the overall playing experience.

The present invention addresses these challenges by introducing a C-shaped tuning clip that seamlessly attaches to the existing main base plate of the tremolo system. The present invention eliminates the need for disassembly, providing a user-friendly solution for musicians seeking efficient tuning adjustments. The clip's ergonomic C-shape ensures a secure fit on the spring plate, allowing players to modify pitch with ease and precision between notes D and E.

One key advantage of the tuning clip lies in its simplicity and ease of installation. Unlike prior art solutions that required intricate adjustments, the present invention enables musicians to attach the tuning clip effortlessly, minimizing downtime and enhancing the overall user experience. This not only caters to seasoned players but also encourages novice musicians to explore pitch modifications without overcoming the complexities of the hardware modifications.

Furthermore, the C-shaped tuning clip does not compromise the guitar's aesthetics or obstruct the player's interaction with the instrument, but rather allows users to easily manipulate pitch with an unobtrusive construction, thus ensuring that the clip seamlessly integrates with the existing tremolo system. By addressing the limitations of prior art, the present invention offers a user-friendly, non-intrusive solution that simplifies the tuning process and enhances the overall playing experience.

### SUMMARY OF THE INVENTION

A tuning slide clip having a C-shaped body. When a lateral force is applied to the present invention, contouring on the body of the invention engages with the tremolo of a guitar, specifically the string locking screws, thus manipulating the sonic qualities of the instrument.

### BRIEF DESCRIPTION OF THE DRAWINGS

FIG. 1 is a perspective view of the present invention coupled to a tremolo.

FIG. 2 is a front view of the present invention.

FIG. 3 is a side view of one embodiment of the present invention.

FIG. 4 is a perspective view of an alternative embodiment of the present invention.

FIG. 5 is a bottom view of the present invention including hidden lines.

FIG. 6 is sectional front view of the present invention.

FIG. 7 is a perspective view of the present invention in the preferred use configuration.

FIG. 8 is a diagram of the present invention showing the configuration of string lock screws.

FIG. 9 is a diagram of the present invention showing an alternate configuration of string lock screws wherein one string lock screw has dropped into the channel.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. Moreover, numerical and chronological descriptors (e.g. “first,” “second,” “third,” etc.) are intended herein, for the purposes of uniquely identifying components, and are not to be interpreted as limiting.

The present disclosure includes many aspects and features. Moreover, while many aspects and features relate to, and are described in the context of a tuning slide clip 1, embodiments of the present disclosure are not limited to use only in this context.

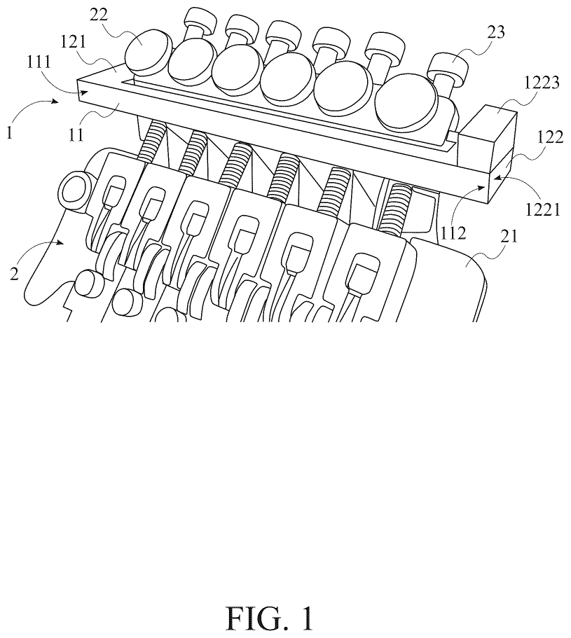

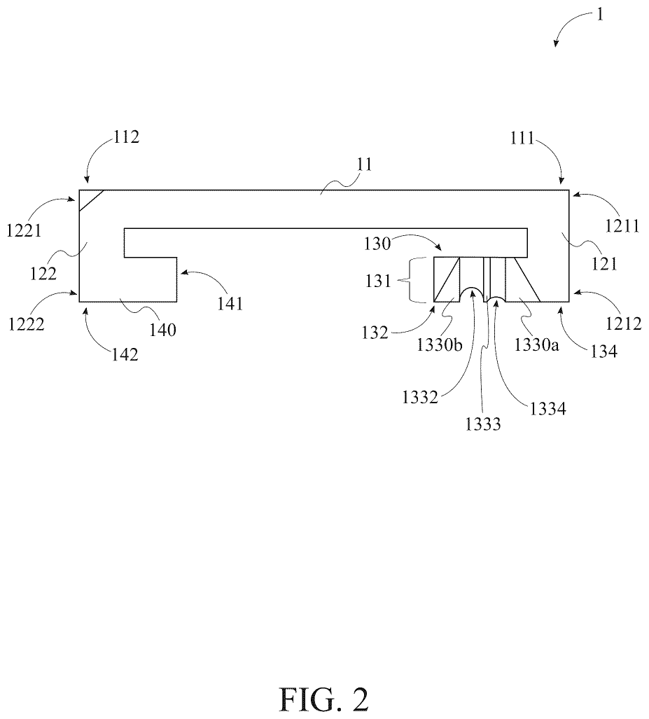

The present invention is a tuning slide clip 1 that removably couples to a guitar tremolo 2, as shown in FIG. 1. To provide context to the present invention, a tremolo 2, as shown in FIG. 2, is a device fixed to a guitar wherein said tremolo 2 comprises a plurality of fine tuning screws 22, a plurality of string locking screws 23, and a main baseplate 21.

As shown in FIG. 1 and FIG. 2, the tuning slide clip 1 is composed of a C-shaped clip comprising an elongated horizontal member 11, a plurality of vertical members 121, 122, and a plurality of truncated members 130,140. In the preferred embodiment of the present invention, the horizontal member 11 comprises a first end 111 and a second end 112 wherein said ends are opposing distal ends of the horizontal member 11. Furthermore, in the preferred embodiment of the present invention, the plurality of vertical members 121, 122 comprises two vertical members, a first vertical member 121 and a second vertical member 122, wherein the first vertical member 121 and the second vertical member 122 extend perpendicularly from the first distal end 111 and the second distal end 112 of the horizontal member 11, respectively.

As shown in FIG. 2, the plurality of truncated members 130,140, comprising a first truncated member 130 and a second truncated member 140, extend perpendicularly inward from the plurality of vertical members 121,122, wherein the first truncated member 130 and the second truncated member 140 perpendicularly extend from the first vertical member 121 and the second vertical member 122, respectively. In the preferred embodiment of the present invention, the horizontal member 11 is parallel to the plurality of truncated members 130,140, wherein the plurality of vertical members 121,122 are interposed between the horizontal member 11 and the respective truncated member 130,140. Furthermore, in the context of the present invention, the plurality of truncated members 130,140 are arranged in a coaxial configuration, separated by a distance. In the context of the present invention, each of the vertical members 121,122 comprises a first end 1211,1221 and a second end 1212,1222; each truncated member 130,140 comprises a distal end 132,141 and a proximal end 134,142; wherein the first end 1211 of the first vertical member 121 is adjacent to the first end 111 of the horizontal member 11, the first end 1221 of the second vertical member 122 is adjacent to the second end 112 of the horizontal member 11, the second end 1212 of the first vertical member 121 is adjacent to the proximal end 134 of the first truncated member 130, and the second end 1222 of the second vertical member 122 is adjacent to the proximal end 142 of the second truncated member 140.

As shown in FIG. 2, in the preferred embodiment of the present invention, the first truncated member 130 comprises a width 131 and a plurality of contours. In the preferred embodiment of the present invention, the plurality of contours comprises an at least one bevel 1330a, 1330b and an at least one channel 1332,1334. In the preferred embodiment of the present invention, the plurality of contours are interposed between the proximal end 134 and the distal end 132 of the first truncated member 130. In the preferred embodiment of the present invention, the at least one bevel comprises a first bevel 1330a and a second bevel 1330b; and the at least one channel comprises a first channel 1332 and a second channel 1334 wherein each channel 1332,1334 traverses the width 131 of the respective truncated member 130. Moreover, in the preferred embodiment of the present invention, first bevel 1330a is adjacent to the second channel 1334 and the second bevel 1330b is adjacent to the first channel 1332. As previously stated, in the context of the present invention, the numeric descriptors are solely for the purpose of identifying components and are in no way limiting to such numerical values. Furthermore, in the preferred embodiment of the present invention, a spacer 1333 is interposed between the first channel 1332 and the second channel 1334. Moreover, in the preferred embodiment of the present invention, the plurality of channels 1332,1334, each comprise a semi-circular cross section.

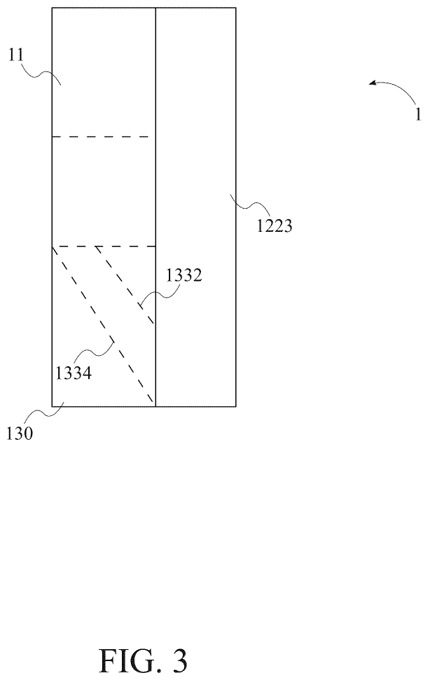

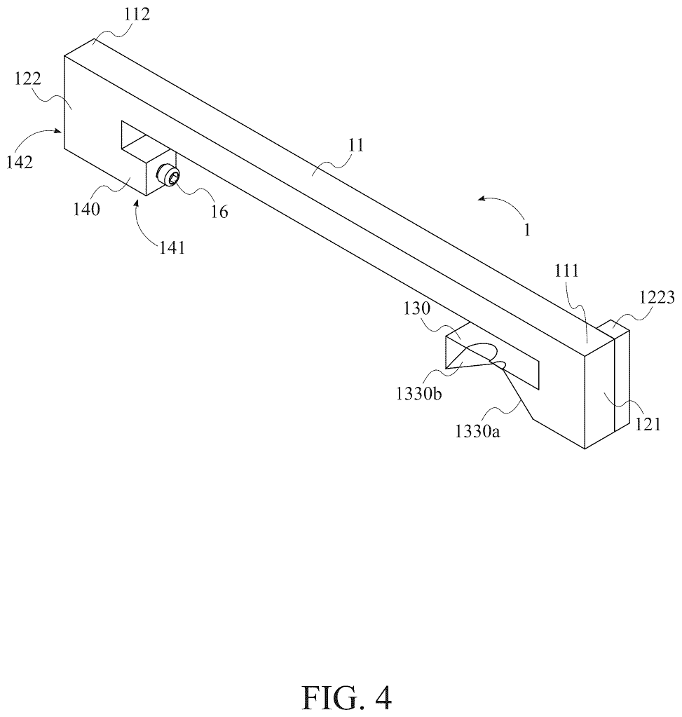

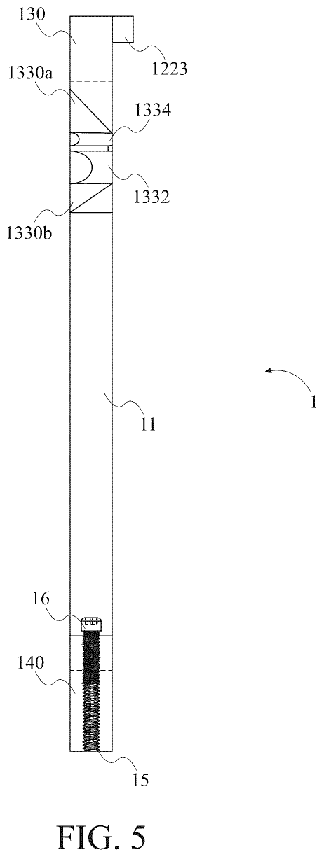

In some embodiment of the present invention, as shown in FIG. 3 and FIG. 4, the present invention further comprises a raised ledge 1223. In the preferred embodiment of the present invention, the raised ledge 1223 is coupled to one of the vertical members 121.122. In the context of the present invention, the tuning slide clip 1 comprises a front face and a rear face wherein the plurality of contours are extruded into the front face and the rear face is flat. In some embodiments of the present invention, the raised ledge 1223 is on the front face of the second vertical member 122 as shown in FIG. 1. In some embodiments of the present invention, the raised ledge 1223 is positioned on the rear face of the first vertical member 121, as shown in FIG. 4 and FIG. 5. In some embodiments, the raised ledge 1223, is coupled to either the front face or the rear face of either the first vertical member 121 or the second vertical member 122. In the context of the present invention, the raised ledge 1223 is coupled to either vertical member 121,122 to provide a user with a raised contour to provide a force to slide the present invention.

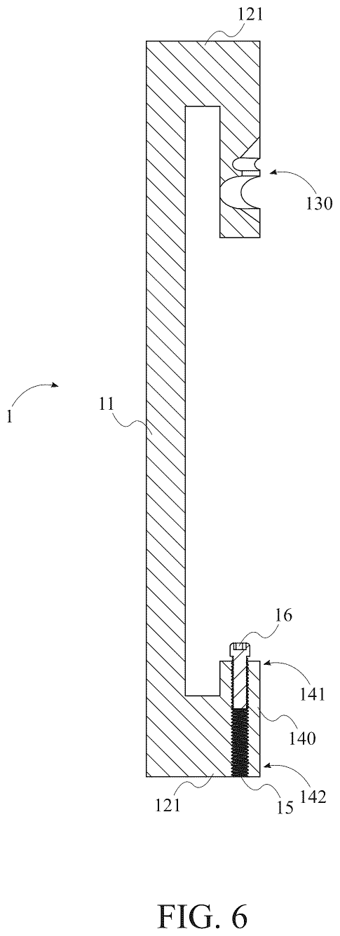

Furthermore, as shown in FIG. 4, FIG. 5, and FIG. 6, the present invention, in some embodiments, comprises a threaded hole 15 and a toggle screw 16. In the preferred embodiment of the present invention, the threaded hole 15 traverses the second truncated member 140 from the distal end 141 towards, and in some embodiments, to, the proximal end 142 of the second truncated member 140. In the preferred embodiment of the present invention, the toggle screw 16 threadedly engages with the threaded hole 15, wherein the toggle screw 16 is inserted into the distal end 141. In the context of the present invention, the toggle screw 16 is adjustable to prevent the tuning slide clip 1 from disengaging from the tremolo 2.

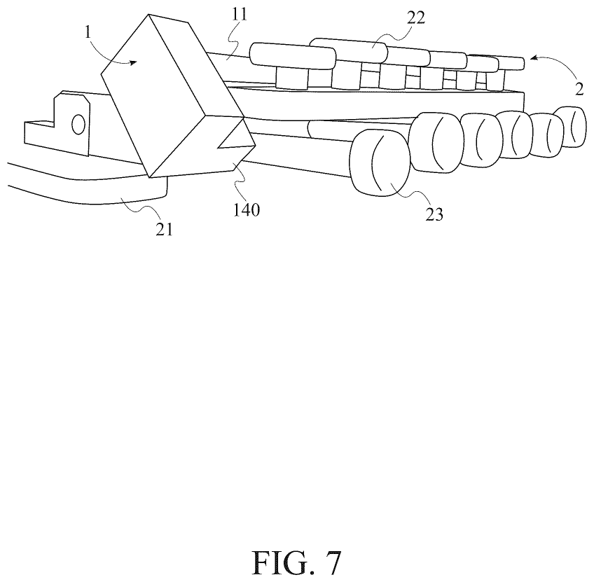

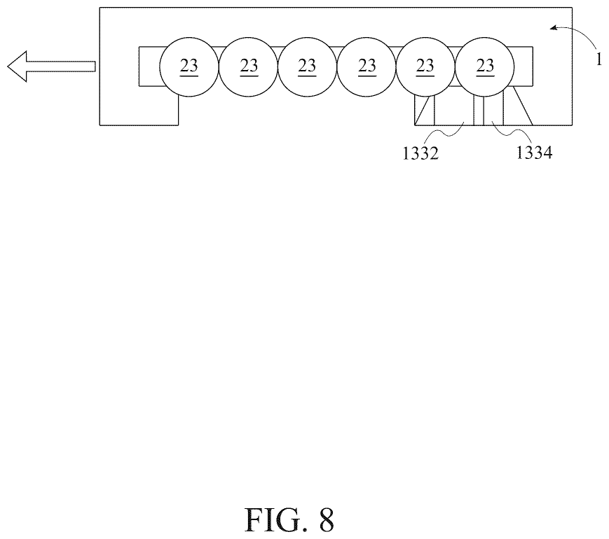

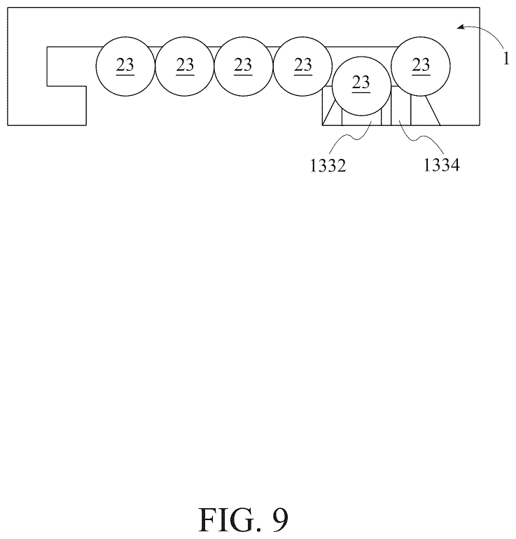

As shown in FIG. 1 and FIG. 7, the tuning slide clip 1 hooks around the main base plate 21 of the tremolo 2, wherein the string lock screws 23 traverse an open inner channel formed by the C-shape of the tuning slide clip 1. In the preferred embodiment of the present invention, as shown in FIG. 8 and FIG. 9, in the intended use of the present invention, the tuning slide clip 1 is slid laterally across the tremolo, whereby the plurality of contours engages with at least one of the string lock screws 23. In the preferred embodiment of the present invention, when one of the string lock screws 23 is aligned with the at least one channel 1332,1334, the respective string lock screw 23 falls into the channel. More specifically, in the preferred embodiment of the present invention, the lateral movement of the tuning slide clip 1 in relation to the tremolo 2, engages and disengages one of the plurality of sting lock screws 23 with the plurality of contours, specifically the at least one channel 1332,1334, whereby an alignment configuration and position possessed by the plurality of string lock screws 23 is changed, as shown in FIG. 8 and FIG. 9, by the lateral movement as at least one string lock screw 23 engages with the at least one channel 1332,1334. In some embodiments, wherein the tuning slide clip 1 comprises a plurality of channels (1332 and 1334), the direction of movement of the present invention, may engage different string lock screws 23 with differing channels 1332,1334. Furthermore, within the preferred use of the present invention, the raised ledge 1223 enables a user to more accessibly apply a force to the present invention, thus allowing the user to more easily slide the present invention across the tremolo 2.

Within the context of the present invention, the tuning slide clip 1 is configured in a manner that prevents the user from being required to disassemble the tremolo 2 when installing the present invention. In doing so, the present invention provides a means of ensuring that the instrument, tremolo 2, and tuning side clip 1 are unaffected by assembly and installation. Furthermore, the configuration of the present invention allows users to easily install and remove the present invention at will.

Although the invention has been explained in relation to its preferred embodiment, it is to be understood that many other possible modifications and variations can be made without departing from the spirit and scope of the invention.

What is claimed is:

1. A tuning slide clip composed of a C-shaped clip comprising an at least one channel;
wherein:
the C-shaped clip couples to a tremolo comprising a plurality of string lock screws; and
the C-shaped clip engages with the plurality of string lock screws whereby lateral movement of the C-shaped clip in relation to the tremolo engages and disengages the at least one channel with at least one of the plurality of string lock screws, thus manipulating an alignment configuration possessed by the plurality of string lock screws.

2. The tuning slide clip, as claimed in claim 1, further comprising an at least one bevel wherein the at least one bevel is adjacent to the at least one channel.

3. The tuning slide clip, as claimed in claim 2 wherein:
the at least one channel comprises:
a first channel; and
a second channel; and
the at least one bevel comprises:
a first channel; and
a second channel;
wherein:
a spacer is interposed between the first channel and the second channel;
the first channel is adjacent to the first bevel; and
the second channel is adjacent to the second bevel.

4. The tuning slide clip, as claimed in claim 1, wherein the C-shaped clip comprises a plurality of truncated members;
the plurality of truncated members are coaxially arranged members separated by a distance;
the at least one channel is extruded into one of the truncated members.

5. The tuning slide clip, as claimed in claim 4 wherein the plurality of truncated members comprises a first truncated member and a second truncated member, wherein:
each of the truncated members comprises a distal end and a proximal end;
the first truncated member comprises the at least one channel wherein said channel is interposed between the distal end and the proximal end of the first truncated member;
the second truncated member comprises a threaded hole;
the threaded hole traversing the second truncated member from the distal end to the proximal end of said second truncated member; and
a toggle screw threadedly engages with the threaded hole.

6. The tuning slide clip as claimed in claim 5, further comprising a horizontal member and a plurality of vertical members;
the horizontal member being parallel to the plurality of truncated members;
horizontal member comprising a first end and a second end wherein said ends are opposite distal ends of the horizontal member;
the plurality of vertical members, comprising a first vertical member and a second vertical member, being interposed between the distal ends of the horizontal member and the proximal ends of the plurality of truncated members;
the first vertical member being interposed between the horizontal member and the first truncated member, comprising the at least one channel; and
the second vertical member being interposed between the horizontal member and the second truncated member.

7. The tuning slide clip, as claimed in claim 6, further comprising a raised ledge, wherein the raised ledge is coupled to one of the plurality of vertical members.

8. The tuning slide clip, as claimed in claim 4, wherein the truncated member comprising the at least one channel further comprise a width;
the at least one channel traversing the width of the truncated member.

9. The tuning slide clip as claimed in claim 3, wherein the C-shaped clip comprises a width;
the first channel and the second channel, both traverse the width of the C-shaped clip.

10. The tuning slide clip, as claimed in claim 1, wherein the at least one channel comprises a semi-circular cross-section.

11. A tuning slide clip composed of a C-shaped clip comprising:
a plurality of truncated members; and
an at least one channel;
wherein:
the C-shaped clip couples to a tremolo comprising a plurality of string lock screws;
the plurality of truncated members comprises two coaxial members;
the at least one channel is extruded into one of the truncated members; and
the C-shaped clip engages with the plurality of string lock screws whereby lateral movement of the C-shaped clip in relation to the tremolo engages and disengages the at least one channel with at least one of the plurality of string lock screws, thus manipulating an alignment configuration possessed by the plurality of string lock screws.

12. The tuning slide clip, as claimed in claim 11, wherein the at least one channel comprises a first channel and a second channel; and
a spacer is interposed between the first channel and the second channel;

13. The tuning slide clip, as claimed in claim 12, further comprising an at least one bevel, wherein:
the at least one bevel comprises a first bevel and a second bevel;
the first bevel is adjacent to the first channel; and
the second bevel is adjacent to the second channel.

14. The tuning slide clip, as claimed in claim 13, wherein the plurality of truncated members comprises a first truncated member and a second truncated member, wherein:
each of the plurality of truncated members comprises a distal end and a proximal end;
the first truncated member comprises the at least one channel; and
the second truncated member comprise a threaded hole traversing from the distal end to the proximal end of the second truncated member.

15. The tuning slide clip, as claimed in claim 14, wherein the threaded hole receives a toggle screw.

16. The tuning slide clip, as claimed in claim 15, further comprising a horizontal member and a plurality of vertical members, wherein:
the plurality of vertical members, comprises two vertical members; and
the plurality of vertical members are perpendicularly interposed between the horizontal member and the plurality of truncated members.

17. A tuning slide clip composed of a C-shaped clip comprising:
a horizontal member;
a plurality of vertical members; and
a plurality of truncated members;
wherein:
the horizontal member comprises a first end and a second end, wherein said first end and second end are opposite distal ends of the horizontal member;
the plurality of vertical members comprising a first vertical member and a second vertical member;
the plurality of truncated members comprising a first truncated member and a second truncated member;
the first vertical member being perpendicularly interposed between the first end of the horizontal member and the first truncated member;
the second vertical member being interposed between the second end of the horizontal member and the second truncated member; and
the first truncated member comprising an at least one channel.

18. The tuning slide clip as claimed in claim 17, wherein the C-shaped clip removably couples to a tremolo, wherein:
the tremolo comprises a plurality of string lock screws;
lateral movement of the C-shaped clip in relation to the tremolo, aligns the at least one channel to at least one of the string lock screws, thereby manipulating a position possessed by the at least one string lock screws.

19. The tuning slide clip as claimed in claim 18, wherein the at least one channel comprises a first channel and a second channel, wherein:
a spacer interposed between the first channel and the second channel.

20. The tuning slide clip, as claimed in claim 19 wherein the second truncated member comprises a threaded hole.
